(19) United States
(12) Patent Application Publication
(10) Pub. No.: US 2010/0228417 A1
(43) Pub. Date: Sep. 9, 2010

(54) DRIVER HANDS ON/OFF DETECTION DURING AUTOMATED LANE CENTERING/CHANGING MANEUVER

(75) Inventors: Jin-Woo Lee, Rochester Hills, MI (US); Yong H. Lee, Troy, MI (US); Bakhtiar Brian Litkouhi, Washington, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/399,290

(22) Filed: Mar. 6, 2009

(51) Int. Cl. G06F 7/00; G05D 1/00

(52) U.S. Cl. 701/23; 701/36

(57) ABSTRACT

A system and method for determining whether a vehicle driver is holding a steering wheel of the vehicle while the vehicle is in an autonomous driving mode. The vehicle will include an electric power steering (EPS) system and may include an active front steering (AFS) system, both of which include a motor that can apply a high frequency and low amplitude perturbation signal to the steering wheel of the vehicle that is not felt by the vehicle driver and does not cause the vehicle to turn, but is able to be detected by a steering angle sensor. The method subtracts a steering angle command signal from the steering angle signal and removes road disturbances, and then determines whether the induced perturbation signal is present in the steering angle sensor signal. If the perturbation signal is present, then the system knows that the vehicle driver is not holding the steering wheel.

### BACKGROUND OF THE INVENTION

1. Field of the Invention

This invention relates generally to a system and method for detecting whether a vehicle driver is holding a steering wheel of the vehicle and, more particularly, to a system and method for determining whether a vehicle driver is holding a steering wheel of the vehicle when the vehicle is in an autonomous or semi-autonomous driving mode by applying a high frequency and low amplitude signal to the steering wheel that is attenuated by the driver holding the steering wheel, but is detectable by a steering angle sensor when the driver lets go of the steering wheel.

2. Description of the Related Art

The automobile industry has been making continuous efforts to enhance the comfort and safety of the occupants of a vehicle, especially the driver. These endeavors have resulted in various technologies, such as advanced driver assistance systems (ADAS) and electronic stability control (ESC) systems. Some of the features of ADAS are adaptive cruise control systems, lane assist systems and driver assist steering systems. ESC systems, on the other hand, use computerized technologies that improve vehicle handling by detecting and preventing unstable conditions.

One known ADAS is an active front steering (AFS) system that adds or subtracts a steering component to the angular movement of the steering wheel in order to reduce the driver effort required to rotate the steering wheel and/or augment the driver steering for improved vehicle safety and stability. The resulting steering angle thus includes the steering input by the driver and the component contributed by the steering system.

The operation of modern vehicles is further becoming more autonomous, i.e., vehicles are able to provide driving control with less driver intervention. Cruise control systems have been on vehicles for a number of years where the vehicle operator can set a particular speed of the vehicle, and the vehicle will maintain that speed without the driver operating the throttle. Adaptive cruise control systems have been recently developed in the art where not only does the system maintain the set speed, but also will automatically slow the vehicle down in the event that a slower moving preceding vehicle is detected using various sensors, such as radar and cameras. Certain modern vehicles also provide autonomous parking where the vehicle will automatically provide the steering control for parking the vehicle. Some vehicle systems intervene if the driver makes harsh steering changes that may affect vehicle stability. Some vehicle systems attempt to maintain the vehicle near the center of a lane on the road. Further, fully autonomous vehicles have been demonstrated that can drive in simulated urban traffic up to 30 mph, observing all of the rules of the road.

The systems described above aid the driver by reducing the driving burden. However, it is typically not desirable to reduce the driver's vigilance and attentiveness, even when such systems are providing some or most of the control of the vehicle. It is generally imperative that the driver puts his/her hands on the steering wheel, and be ready to take over the steering control whenever the situation demands. Further, various steering actuators used in an active front steering systems function properly only when the driver has his hands on the steering wheel while the vehicle is in motion.

### SUMMARY OF THE INVENTION

In accordance with the teachings of the present invention, a system and method are disclosed for determining whether a vehicle driver is holding a steering wheel of the vehicle while the vehicle is in an autonomous or semi-autonomous driving mode. The vehicle will include an electric power steering (EPS) system and may include an active front steering (AFS) system, both of which include a motor that can apply a high frequency and low amplitude perturbation signal to the steering wheel of the vehicle that is not felt by the vehicle driver and does not cause the vehicle to turn, but is able to be detected by a steering angle sensor. The method subtracts a steering angle command signal from the steering angle sensor signal and removes road disturbance signals, and then determines whether the induced perturbation signal is present in the steering angle sensor signal. If the perturbation signal is present in the steering angle sensor signal, then the system knows that the vehicle driver is not holding the steering wheel.

Additional features of the present invention will become apparent from the following description and appended claims, taken in conjunction with the accompanying drawings.

### BRIEF DESCRIPTION OF THE DRAWINGS

FIG. 1 is a plan view of a vehicle steering system; and

FIG. 2 is a schematic block diagram of a system for determining whether a vehicle driver is holding a vehicle steering wheel of the vehicle when an autonomous or semi-autonomous system is activated.

### DETAILED DESCRIPTION OF THE EMBODIMENTS

The following discussion of the embodiments of the invention directed to a system and method for determining whether a vehicle driver is holding a steering wheel of the vehicle is merely exemplary in nature, and is in no way intended to limit the invention or its applications or uses. For example, the invention described below has particular application for determining whether a vehicle driver is holding a steering wheel of the vehicle when the vehicle is in an autonomous or semi-autonomous driving mode where a lane change or lane centering steering command is being given. However, the invention may have application for vehicle systems other than autonomous or semi-autonomous systems to determine if a vehicle driver is holding the steering wheel of the vehicle.

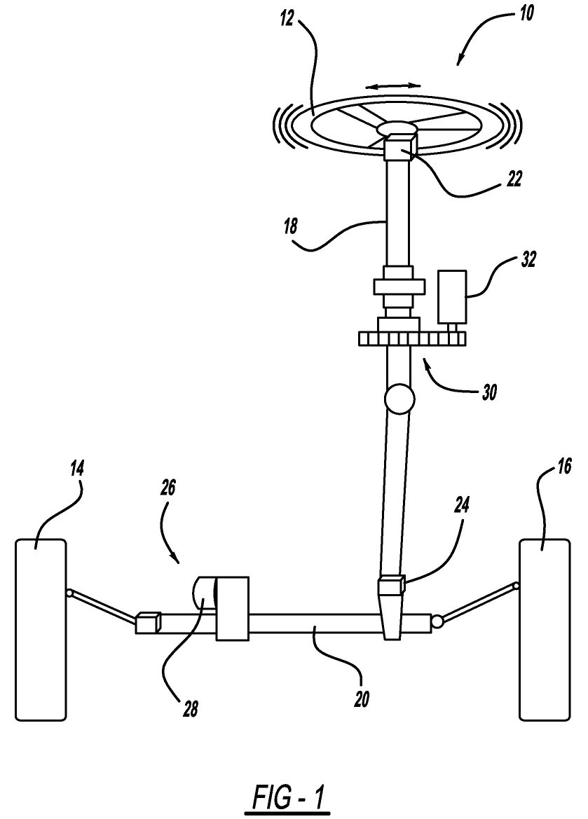

FIG. 1 is a plan view of a vehicle steering system 10 including a steering wheel 12 for steering wheels 14 and 16 of a vehicle. The steering wheel 12 is coupled to the wheels 14 and 16 through a steering column 18 and an axle 20 in a manner that is well understood by those skilled in the art so that when the driver turns the steering wheel 12 the wheels 14 and 16 turn accordingly. A steering angle sensor 22 mounted to the steering column 18 measures the rotation of the steering wheel 12 and the steering column 18 and provides a steering angle signal indicative of same. A torque sensor 24 mounted to the steering column 18 measures the torque on the steering column 18 and provides a torque signal indicative of same.

The steering system 10 includes an electric power steering (EPS) system 26 having an electric motor 28 mounted to the axle 20 that provides electric steering assist in response to the vehicle driver turning the steering wheel 12 in a manner that is well understood in the art. In other words, when the vehicle driver turns the steering wheel 12, the EPS system 26 turns the wheels 14 and 16 the amount commanded by the vehicle driver so that the turning of the wheels 14 and 16 on the roadway is easier. The vehicle system 10 also includes an active front steering (AFS) system 30 including an electric motor 32 mounted to the steering column 18. AFS systems are well known to those skilled in the art that provide additional steering, or corrective steering, in various types of vehicle stability control systems in connection with the vehicle driver turning the steering wheel 12, where the AFS system 30 decouples the steering wheel 12 from the wheels 14 and 16.

As will be discussed in detail below, the present invention provides a technique for determining whether the vehicle driver is holding onto the steering wheel 12 when the vehicle is in an autonomous or semi-autonomous driving mode where the vehicle steering, such as lane changing and lane centering steering commands, are being made by the vehicle without driver intervention. Vehicle systems that provide such autonomous or semi-autonomous are currently being developed in the art. Current technology requires that the vehicle driver maintain contact with the steering wheel 12 as a backup safety feature for over-riding the autonomous or semi-autonomous vehicle system, and thus, a technique for making sure that the vehicle driver is holding onto the steering wheel 12 is provided. The particular vehicle will include the EPS system 26, but may or may not include the AFS system 30, where the technique described below for determining if the vehicle driver is holding the steering wheel 12 will operate the same for either vehicle.

In general, the technique for determining if the vehicle driver is holding onto the steering wheel 12 includes inducing a perturbation signal onto the steering wheel 12 that has a relatively high frequency and a low amplitude. The frequency and amplitude of the signal are selected so that the driver will not feel the vibration on the steering wheel 12 and the vibration will not have an effect on the actual turning of the vehicle, but the induced vibration is detectable by the steering angle sensor 22. The frequency of the perturbation signal is also selected to be distinct from the road induced steering disturbances. When the vehicle driver is holding onto the steering wheel 12, the induced perturbation on the steering wheel 12 is attenuated by the vehicle driver so that the vibration is not detected by the steering angle sensor 22. If the vehicle driver lets go of the steering wheel 12 so that the induced perturbation is not attenuated, then the steering angle sensor 22 will detect the perturbation on the steering wheel 12. The system may cause a warning signal to be issued or provide some type of audible or visual indication that the vehicle driver is not holding onto the steering wheel 12.

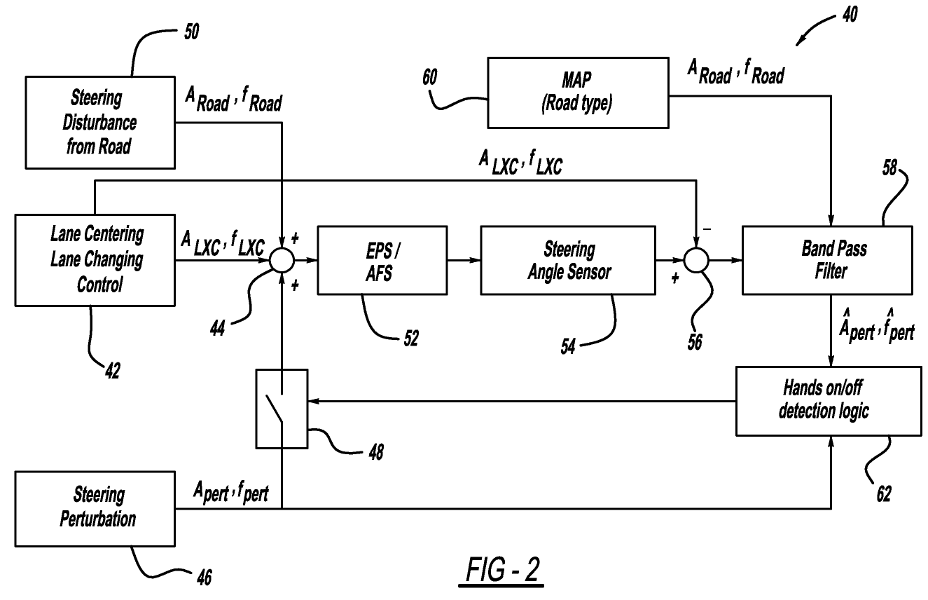

FIG. 2 is a schematic block diagram of a system 40 for detecting whether the vehicle driver is holding onto the steering wheel 12 in the manner as discussed above. When the vehicle is in the autonomous or semi-autonomous driving mode, steering command signals are provided by the autonomous driving system for lane centering and lane changing control at box 42, where the command signals have an amplitude A_{LXC} and a frequency f_{LXC}. The steering command signals are sent to a summation junction 44. When the vehicle is in the autonomous or semi-autonomous driving mode, a steering perturbation signal that has an amplitude Aₚₑᵣₜ and a frequency fₚₑᵣₜ is provided at box 46 and sent to the summation junction 44 through a switch 48, which will be closed when the system 40 is in the autonomous or semi-autonomous mode. Further, as the vehicle is traveling down the roadway, the tires 14 and 16 will be subject to disturbances on the road. Road disturbance signals that have an amplitude A_{Road} and a frequency f_{Road are provided} at box 50, which are also summed at the summing junction 44. The combination of these three signals is sent to the EPS system 26 and the AFS system 30, represented by box 52, which provides the actual steering of the vehicle, as discussed above.

The perturbation signal is induced on the steering wheel 12 by the motor 28 in the EPS system 26 if the vehicle is not equipped with the AFS system 30, and is provided by the motor 32 in the AFS system 30 if the vehicle is equipped with the AFS system 30. The steering angle sensor 22 detects the steering signal at box 54, which includes steering from all three sources, namely, the steering command signal, the induced perturbation signal and the road disturbance signal. The steering angle sensor signal is sent to a differencing junction 56 along with the steering command signal from the box 42 so that the steering command signal is removed from the sensor signal so that only the perturbation signal and the road disturbance signal portion remain in the steering angle sensor signal. The remaining portion of the steering angle sensor signal is then sent to a band-pass filter 58 to filter out the road disturbance signal. In one embodiment, the disturbance of the road is provided by the road type from a map database 60 and may or may not be available on the vehicle. If the road disturbance information is not available from a map database, then it is ignored in the analysis and is not filtered by the band-pass filter 58.

The output signal from the band-pass filter 58 is some variation or distortion of the perturbation signal and has an amplitude Âₚₑᵣₜ and the frequency \hat{f}ₚₑᵣₜ. The distorted perturbation signal is applied to a hands on/off detection logic box 62. The detection logic box 62 also receives the actual perturbation signal from the perturbation box 46 and compares the two signals to determine whether the perturbation exists on the steering wheel 12. If the hands on/off detection logic box 62 does not detect a signal similar to the distorted perturbation signal from the band-pass filter 58, then the vehicle driver is holding the steering wheel 12 and has attenuated out the steering perturbation signal, where it is not detected by the steering angle sensor 22. However, if the comparison between the perturbation signals are close together within some threshold, then the disturbance signal is present on the steering wheel 12, meaning that the vehicle driver has let go of the steering wheel 12.

The logic box 62 also controls the switch 48 where it can disconnect the perturbation signal from the summation junction 44. The steering perturbation signal can be turned off or lowered for smooth steering feel if the driver hands on is detected. Further, during a hands-on situation, the steering perturbation signal can be applied periodically or continuously if haptic feedback is desired.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for determining whether a vehicle driver is holding onto a vehicle steering wheel, said method comprising:
providing a perturbation signal to the steering wheel that causes the steering wheel to vibrate; and
determining that the vehicle driver is not holding onto the steering wheel of the vehicle if the perturbation signal is detected by vibrations on the steering wheel.

2. The method according to claim 1 wherein providing a perturbation signal to the steering wheel includes providing the perturbation signal by an electric motor in an active front steering system on the vehicle.

3. The method according to claim 1 wherein providing a perturbation signal to the steering wheel includes providing the perturbation signal by an electric motor in an electric power steering system on the vehicle.

4. The method according to claim 1 wherein detecting the perturbation signal includes using a steering angle sensor.

5. The method according to claim 1 further comprising filtering out a road disturbance signal from a steering angle signal that is used to detect the perturbation signal before determining that the perturbation signal indicates that a vehicle driver is not holding onto the vehicle steering wheel.

6. The method according to claim 5 wherein filtering out the road disturbance signal includes determining road type from a map database.

7. The method according to claim 1 wherein the method determines whether the vehicle driver is holding onto the vehicle steering wheel when the vehicle is in an autonomous or semi-autonomous driving mode.

8. The method according to claim 1 further comprising subtracting a steering command signal from the steering angle signal before determining that the perturbation signal indicates that the vehicle driver is not holding onto the vehicle steering wheel.

9. A method for determining whether a vehicle driver is holding onto a vehicle steering wheel, said method comprising:
providing a perturbation signal to the steering wheel that causes the steering wheel to vibrate;
determining that the vehicle is in an autonomous or semi-autonomous driving mode;
providing a steering command signal for steering the vehicle while it is in the autonomous or semi-autonomous driving mode;
detecting the steering angle of the steering wheel and providing a steering angle signal;
subtracting the steering command signal from the steering angle signal; and
determining whether the perturbation signal exists in the steering angle signal after the steering command signal has been subtracted from the steering angle signal.

10. The method according to claim 9 further comprising filtering out a road disturbance signal from the steering angle signal before determining whether the perturbation signal exists in the steering angle signal.

11. The method according to claim 10 wherein filtering out the road disturbance signal includes determining road type from a map database.

12. The method according to claim 9 wherein providing a perturbation signal to the steering wheel includes providing the perturbation signal by an electric motor in an active front steering system on the vehicle.

13. The method according to claim 9 wherein providing a perturbation signal to the steering wheel includes providing the perturbation signal by an electric motor in an electric power steering system on the vehicle.

14. The method according to claim 9 wherein detecting the steering angle includes using a steering angle sensor.

15. A system for determining whether a vehicle driver is holding onto a vehicle steering wheel, said system comprising:
means for providing a perturbation signal to the steering wheel that causes the steering wheel to vibrate;
means for determining that the vehicle is in an autonomous or semi-autonomous driving mode;
means for providing a steering command signal for steering the vehicle while it is in the autonomous or semi-autonomous driving mode;
means for detecting the steering angle of the steering wheel and providing a steering angle signal;
means for subtracting the steering command signal from the steering angle signal; and
means for determining whether the perturbation signal exists in the steering angle signal after the steering command signal has been subtracted from the steering angle signal.

16. The system according to claim 15 further comprising means for filtering out a road disturbance signal from the steering angle signal before determining whether the perturbation signal exists in the steering angle signal.

17. The system according to claim 16 wherein the means for filtering out the road disturbance signal determines road type from a map database.

18. The system according to claim 15 wherein the means for providing a perturbation signal to the steering wheel includes an electric motor in an active front steering system on the vehicle.

19. The system according to claim 15 wherein the means for providing a perturbation signal to the steering wheel includes an electric motor in an electric power steering system on the vehicle.

20. The system according to claim 15 wherein the means for detecting the steering angle uses a steering angle sensor.
